(19) United States
(12) Patent Application Publication
(10) Pub. No.: US 2009/0093206 A1
(43) Pub. Date: Apr. 9, 2009

(54) Onboard air conditioning system

(75) Inventors: Takuya Okita, Wako (JP); Toru Nakagawa, Wako (JP); Satoru Tsuchiya, Wako (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 12/283,730

(22) Filed: Sep. 15, 2008

(30) Foreign Application Priority Data
Oct. 9, 2007 (JP) 2007-263393
Oct. 9, 2007 (JP) 2007-263554

(51) Int. Cl. B60H 1/00

(52) U.S. Cl. 454/143

(57) ABSTRACT

In an onboard air conditioning system, a light source (25) for conditioned air is provided in association with an air outlet (31), and the color of the light emitted from the light source changes in dependence on the temperature of the conditioned air. The light source may consist of a linear light source at least partly surrounding the air outlet. Thereby, the vehicle occupant can visually recognize the operating condition of the air conditioning system. The air outlet may be at least partly-surrounded by an annular duct (20) defining a central chamber (21) that has a closed bottom and an open top defining the air outlet, the annular air duct being provided with a communication hole (23) communicating an interior of the annular duct with the central chamber, and the air outlet is covered by an air permeable sheet (30). The conditioned air is thus turned into a mild one because the central chamber is typically large in size, and the velocity of the expelled air may be extremely small for a given volume of conditioned air.

### TECHNICAL FIELD

The present invention relates to an onboard air conditioning system typically for use in a motor vehicle, and in particular to an onboard air conditioning system that can visually indicate the temperature of the conditioned air.

### BACKGROUND OF THE INVENTION

An onboard air conditioning system for a motor vehicle is typically provided with a control board on an instrument panel or a center console so that a vehicle operator or a passenger may be able to manually operate the air conditioning system. In the case of a manually controlled air conditioning system, the control board typically includes a temperature selector for selecting a desired temperature of the controlled air and an air flow selector. In the case of an automatic air conditioning system, the control board includes a temperature setting switch that enables the user to set a desired temperature for a thermostat control, and the set temperature is indicated on a small LCD panel included in the control board. See Japanese patent laid open publication No. 07-149139.

In such an automatic air conditioning system, the selected temperature is only numerically indicated on the control board, and the user is unable to recognize the actual temperature of the conditioned air that is expelled from air outlets which are provided in interior members such as a center console and an instrument panel unless the use places his or her hand or face close to the air outlet. Therefore, there is a demand for a system that enables the user to more readily sense the temperature of the conditioned air that flows out of an air outlet of an air conditioning system.

Another problem associated with the conventional air conditioning system is that the conditioned air is expelled from each air outlet as an air flow having a significant directivity. When the conditioned air directly flows onto or impinges upon a part of the face, arm or other part of the vehicle occupant, it may not be comfortable to the vehicle occupant. Therefore, a number of air outlets are provided in a cabin so that the effect of the air conditioning may be homogeneous over the entire cabin as much as possible. Also, each air outlet is often equipped with vanes so that the direction of the air flow may be adjusted so that the discomfort to the vehicle occupant may be minimized. See Japanese patent publications No. 2003-034117 and No. 2005-162073, for instance. However, there still is a demand that the conditioned air may be introduced into the cabin in a more homogeneous manner with a minimum directivity so that the comfort of the vehicle occupant may be maximized.

### BRIEF SUMMARY OF THE INVENTION

In view of such problems of the prior art, a primary object of the present invention is to provide an onboard air conditioning system that allows the user to readily sense the temperature of the conditioned air flowing out of an air outlet.

A second object of the present invention is to provide an onboard air conditioning system that allows the user to visually sense the temperature of the conditioned air flowing out of an air outlet.

A third object of the present invention is to provide an onboard air conditioning system that can introduce conditioned air into a cabin in a mild and comfortable manner.

A fourth object of the present invention is to provide an onboard air conditioning system that can introduce conditioned air into a cabin at an extremely low speed and with a minimum directivity.

According to the present invention, at least some of such objects can be accomplished by providing an onboard air conditioning system, comprising: an air duct incorporated in an interior member of a cabin; an air outlet formed in the interior member to expel conditioned air from the air duct to the cabin; a light source provided in association with the air outlet; and a controller for changing color of light emitted from the light source in dependence on a temperature of the conditioned air.

Thereby, the vehicle occupant is enabled to visually recognize the operating state of the air conditioning system without any effort, and this increases the comfort of the vehicle occupant. In particular, if the color of the light emitted from the light source has a color temperature which becomes higher with a rise in the temperature of the conditioned air, or the color of the light emitted from the light source has a wavelength which becomes longer with a rise in the temperature of the conditioned air, the vehicle operator can obtain more detailed information on the mode of operation of the air conditioning system. The color may change either continually from one end of color spectrum to another or discretely between two or more colors.

Such effects can be even more enhanced if the air outlet is covered by an air permeable sheet having an at least partly light transmissive property, and the light source is provided behind the air permeable sheet in a part of the air duct adjacent to the air outlet, and/or the light source comprises a linear light source extending at least partly along the air outlet.

According to a particularly preferred embodiment of the present invention, the air duct comprises an annular duct at least partly surrounding the air outlet, and defining a central chamber that has a closed bottom and an open top defining the air outlet, the annular air duct being provided with a communication hole communicating an interior of the annular duct with the central chamber.

Therefore, the conditioned air conveyed through the air duct is introduced into the annular duct, and is then expelled from the communication hole into the central chamber. The conditioned air is turned into a mild one because the central chamber is typically large in size, and the velocity of the expelled air may be extremely small for a given volume of conditioned air. This adds to the comfort of the vehicle occupant. The fact that the direction of the air flow changes as it is passes through the central chamber from the communication hole to the air outlet contributes to the comfort of the vehicle occupant. Typically, a plurality of communicating holes are provided in an inner circumferential wall of the annular duct surrounding the central chamber along a length thereof.

According to a preferred embodiment of the present invention, the light source is mounted on the annular duct, typically in the form of a linear light source or an array of discrete light sources extending or arranged along the length of the annular duct. The interior member may comprise an instrument panel, door garnish, sheet bottom, seat back and rear shelf of a motor vehicle.

The air outlet may comprise a defroster air outlet formed in the instrument panel along a lower edge of a front windshield, the light source extending along a length of the defroster air outlet, preferably concealed from a direct view of the vehicle occupant so that the defroster air outlet may be illuminated indirectly.

### BRIEF DESCRIPTION OF THE DRAWINGS

Now the present invention is described in the following with reference to the appended drawings, in which:

FIG. 1 is an overall perspective view of an interior of a motor vehicle embodying the present invention;

FIG. 2 is a perspective view showing an embodiment of the present invention applied to an instrument panel of the motor vehicle;

FIG. 3 is a sectional view taken along line II-II of FIG. 2;

FIG. 4 is a block diagram showing the control unit of the air conditioning system embodying the present invention; and

FIG. 5 is an exploded perspective view of another embodiment of the present invention applied to a door garnish.

### DETAILED DESCRIPTION OF THE PREFERRED EMBODIMENTS

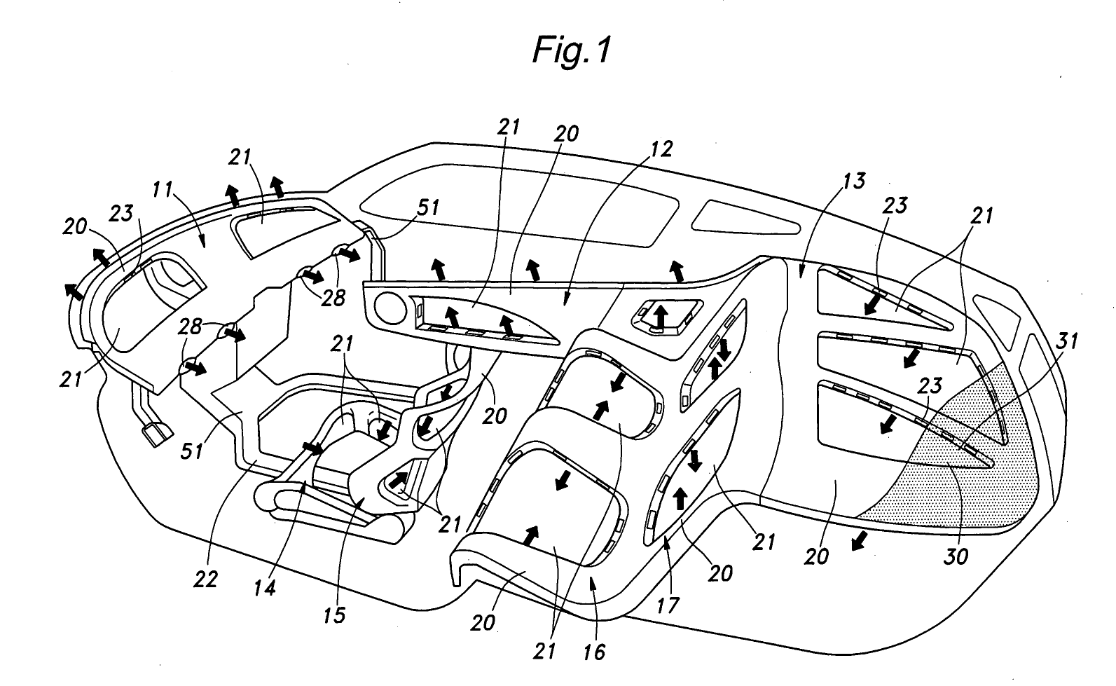

FIGS. 1 to 5 shows an onboard air conditioning system for a motor vehicle embodying the present invention. Referring to FIG. 1, this air conditioning system comprises air outlets 31 formed in various interior members such as an instrument panel 11, door garnishes 12, a rear shelf 13, front seat bottoms 14, front seat backs 15, rear seat bottoms 16 and rear seat backs 17.

Each air outlet 31 is defined by an annular duct 20 which in turn defines a central chamber 21 which has a closed bottom and an open top that defines the corresponding air outlet 31. The annular duct 20 may entirely surround the air outlet 31 as shown in the illustrated embodiment, but may also only partly surround the air outlet 31. The annular duct 20 communicates with a corresponding main duct 22, and is provided with a plurality of communication holes 23 so as to face the central chamber 21. The air outlet 31 is covered by an air permeable sheet 30 typically made of woven or knit fabric or perforated sheet. The air permeable sheet 30 may extend to the surrounding area so as to normally conceal the presence of the air outlet 31 or may also be confined to the opening area of the air outlet 31 so as to emphasize the presence of the air outlet 31.

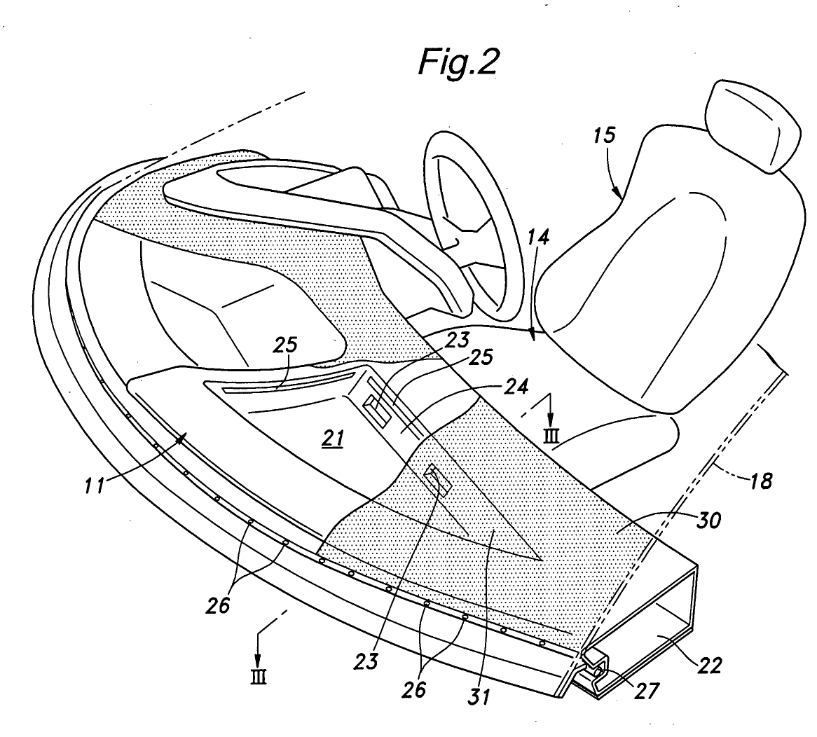

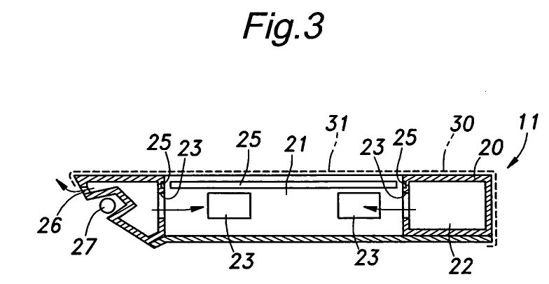

FIGS. 2 and 3 show the instrument panel 11 in greater detail. The instrument panel 11 extends along the lower edge of a front windshield 18 on the inboard side thereof. The instrument panel 11 is fitted with a triangular annular duct 20 communicating with a main duct 22 and a triangular central chamber 21 which has a closed bottom and an open top, and has a certain depth. This central chamber 21 is covered from the top by an air permeable sheet 31. A plurality of communication holes 23 are formed on the side of the annular duct 20 facing the central chamber 21 at a regular interval along the triangular edge of the central chamber 21. The main duct 22 communicates with a central duct 51 (FIG. 1) into which the conditioned air from a main air conditioning unit flows directly. Therefore, the conditioned air conducted through the main duct 22 is passed on to the annular duct 20, and is expelled into the central chamber 21 from each communication hole 23 of the annular air duct 20.

The air permeable sheet 30 may be made of any material as long as it permits passage of air, and preferably forms a part of the upholstery covering the interior members of the cabin that continuously merges with the surrounding upholstery member. Therefore, the air permeable sheet 30 is typically given with an aesthetically attractive texture, color and appearance. The air permeable sheet 30 may also be made of perforated metal or plastic sheet having a relatively high rigidity as well as more pliant and flexible woven or knit fabric or a perforated flexible sheet. If necessary, the air permeable sheet 30 may be a combination of a relatively rigid perforated sheet and pliant and flexible fabric covering it. Without regard to the selection of the material for the air permeable sheet 30, the entire area of the central chamber 21 preferably serves as the air outlet 31.

As the conditioned air from the central duct 51 flows through the main duct 22 and annular duct 20, and expelled from the communication holes 23 into the central chamber 21, the flow velocity of the conditioned air diminishes. This in turn causes a rise in the internal pressure of the central chamber 21, and the conditioned air seep through the air permeable sheet 30 over an area corresponding to that of the central chamber 21.

Therefore, the conditioned air is expelled from the air outlet 31 over a large area so that the conditioned air is introduced into the cabin in a diffused condition at a low speed without any significant directivity. The air flowing out of the air outlet 31 is thus prevented from blowing directly onto the person of the vehicle occupant. Because the air moves at a low speed but over a large area, the air flow is delivered to the vehicle occupant in a mild manner, and is able to transfer a large amount of heat without causing discomfort to the vehicle occupant as opposed to a localized air flow of a relatively high velocity.

The communication holes 23 of the annular duct 21 are formed in an inner circumferential wall 24 thereof, and are therefore directed laterally while the air outlet 31 that expels air out of the central chamber 21 is directed away from the major surface of the interior member which consists of the upper face of the instrument panel 11. Because the direction of the air flow is sharply bent in the central chamber 21, the air flow from the communication holes 23 is prevented from being blown into the cabin in a localized manner. This also contributes to turning the air flow into a mild one and minimizing the discomfort to the vehicle occupant.

A linear light source 25 is attached to the surface of the inner circumferential wall 24 entirely or partly around the entire circumference. The light source 25 is located behind the air permeable sheet 30 (or inside the central chamber 21), and illuminates the peripheral part of the central chamber 21. The air permeable sheet 30 is at least partly light transmissive, and diffuses the light from the light source 25 as it passes through the air permeable sheet 30.

The light source 25 is turned on when the air conditioning system is in operation or when air is blown from the air outlet 31 so that the user may visually recognize if conditioned air is blowing out of the air outlet 31. The light source may consist of an array of LED chips of three different colors (RGB) arranged in a regular pattern, and the emitted light may change color in dependence on the temperature of the conditioned air flowing out of the air outlet 31. Optionally, the intensity of the emitted light may be varied in dependence on the flow rate of the conditioned air flow flowing out of the air outlet 31.

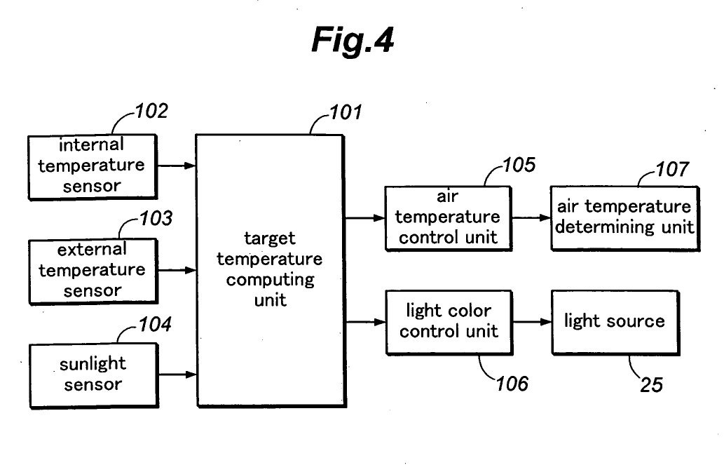

FIG. 4 is a block diagram of the control unit for the air conditioning system of the illustrated embodiment. The control unit comprises a microprocessor that performs various functions by executing software programs. One such function is designated as a target air temperature computing unit 101 which receives information signals from an internal temperature sensor 102 for detecting a temperature within the cabin, an external temperature sensor 103 for detecting a temperature of the exterior and a sunlight sensor 104 for detecting an intensity of solar radiation, and computes a target air temperature according to a prescribed algorithm. The output of the target air temperature computing unit 101 is forwarded to an air temperature control unit 105 and a light color control unit 106.

The air temperature control unit 105 controls an air temperature determining unit 107 which may comprise an air mixing damper so that a conditioned air of a desired temperature may be blown out from the air outlet 31 in dependence on the internal temperature, external temperature and solar radiation.

The light color control unit 106 controls the color of the light emitted from the light source depending on the target air temperature computed by the target air temperature computing unit 101. In this light color control, the emitted light may be red in a heating air conditioning mode, and blue in a cooling air conditioning mode. More preferably, the emitted light is more reddish with an increase in the target air temperature and more bluish with a decrease in the target air temperature so that the light emitted from the light source has a color temperature which becomes higher with a rise in the temperature of the conditioned air, or so that the color of the light emitted from the light source has a wavelength which becomes longer with a rise in the temperature of the conditioned air. Thereby, the vehicle occupant is enabled to visually recognized the operating state (temperature of the conditioned air) of the air conditioning system.

The color of the emitted light may be thus varied from one end of color spectrum to another in a continuous manner, or discretely between two or more colors. If desired, the temperature of the conditioned air may also be directly measured in a suitable part of the air duct 20, 22 so that the color of the emitted light may be varied in dependence on the directly measured temperature of the conditioned air.

The side wall of the annular duct 20 of the instrument panel 11 facing the front windshield 18 is provided with a defroster outlet 26 including an array of communication holes arranged along the lower edge of the front windshield 18 at a regular interval. The part of the side wall of the annular duct 20 immediately below the defroster outlet 26 is formed with a linear recess extending in parallel with the defroster outlet 26 and receiving a linear light source 27 extending along the length of the recess. The light emitted from the light source 27 thus illuminates a gap defined between the lower edge of the front windshield 18 and the opposing side of the annular duct 20 so that the defroster outlet 26 is indirectly illuminated by the light source 27. This light source 27 is similarly controlled as the light source 25 so that the vehicle occupant is able to visually recognize if air is blowing out from the defroster outlet 26 from the presence of the illumination and if the air blowing out from the defroster outlet is cold or warm from the color of the illuminating light.

As shown in FIG. 1, a plurality of face air outlets 28 may be formed in the interior member 20 of the instrument panel 11. The face air outlets 28 directly communicate with the main duct 22 and are appropriately controlled by a damper not shown in the drawing so that conditioned air may be directly directed to the vehicle occupant when desired.

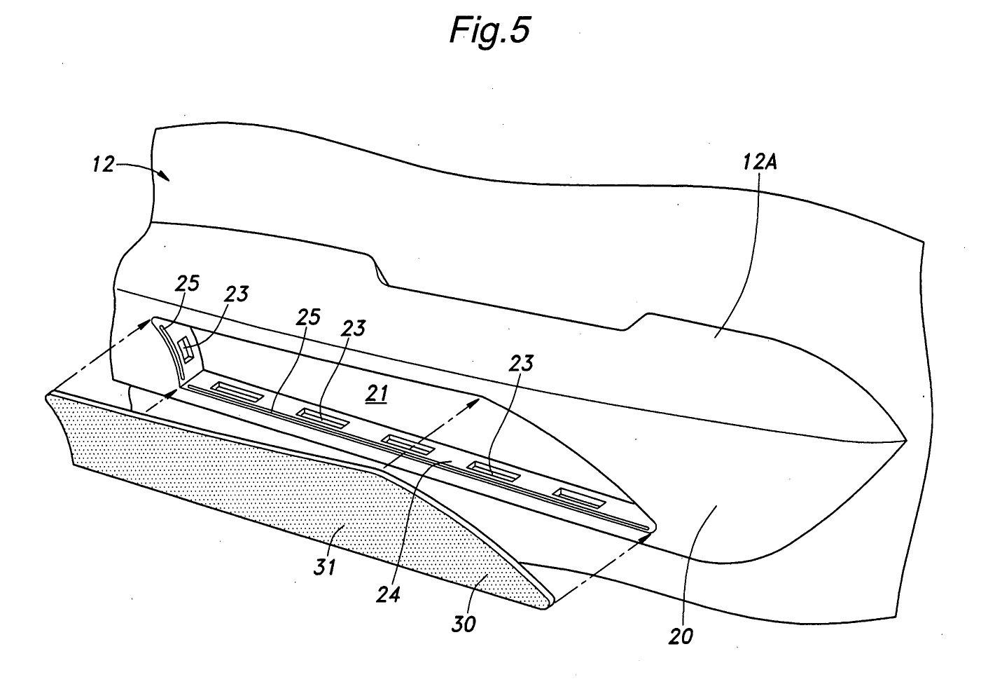

FIG. 5 shows one of the door garnishes 12 in greater detail. The parts corresponding to those shown in FIGS. 1 to 3 are denoted with like numerals without repeating the description of such parts.

The door garnish 12 comprises an arm rest 12A, and an air outlet 31 is provided on a side of the arm rest 12A facing the interior of the cabin. In this case, the arm rest 12A is provided with a somewhat distorted rectangular recess that defines a central chamber 21 and an air outlet 31, and the interior of the arm rest 21 forms an annular duct having an inner circumferential wall 24 surrounding the central recess 21. An array of communication holes 23 are formed in the inner circumferential wall 24 along the length thereof at a regular interval. The interior of the arm rest 12A is otherwise substantially enclosed, and communicates with the main duct 22. The air outlet 31 is covered by an air permeable sheet 30 which in this case is supported by a relatively rigid frame and fitted into the air outlet 31. The air permeable sheet 30 supported by the rigid frame may be secured in position either by press fitting, by using a bonding agent or by using fasteners that permit replacement.

The air permeable sheet 30 of the air outlet 31 of the arm rest 12A is typically made of woven or knit fabric or perforated sheet, and may be similar to that used for the air outlets 31 of the instrument panel.

Therefore, in this case also, the conditioned air is introduced into the cabin over the opening area of the air outlet 31, and is blown into the cabin in a diffused manner without any significant directivity. Because the air moves at a low speed but over a large area, the air flow is delivered to the vehicle occupant in a mild manner, and is able to transfer a large amount of heat without causing discomfort to the vehicle occupant as opposed to a localized air flow of a relatively high velocity.

The inner circumferential wall 24 of the annular frame 20 of the arm rest 12A is also provided with a linear light source 25 extending along the length thereof. This light source 25 also emits illuminating light from behind the air permeable sheet 30, and illuminates the air outlet 31 along the peripheral edge thereof. This light source 25 changes color depending on the temperature of the conditioned air emitted from the air outlet 31.

A similar structure is used for the air outlet 31 of each of the rear shelf 13, front seat bottoms 14, front seat backs 15, rear seat bottoms 16 and rear seat backs 17, and these air outlets 31 jointly achieve a mild and comfortable temperature control of the entire cabin.

Although the present invention has been described in terms of preferred embodiments thereof, it is obvious to a person skilled in the art that various alterations and modifications are possible without departing from the scope of the present invention which is set forth in the appended claims.

The contents of the original Japanese patent application on which the Paris Convention priority claim is made for the present application and the contents of any related prior art mentioned in the disclosure are incorporated in this application by reference.

1. An onboard air conditioning system, comprising:
an air duct incorporated in an interior member of a cabin;
an air outlet formed in the interior member to expel conditioned air from the air duct to the cabin;
a light source provided in association with the air outlet; and
a controller for changing color of light emitted from the light source in dependence on a temperature of the conditioned air.

2. The onboard air conditioning system according to claim 1, wherein the color of the light emitted from the light source has a color temperature which becomes higher with a rise in the temperature of the conditioned air.

3. The onboard air conditioning system according to claim 1, wherein the color of the light emitted from the light source has a wavelength which becomes longer with a rise in the temperature of the conditioned air.

4. The onboard air conditioning system according to claim 1, wherein the air outlet is covered by an air permeable sheet having an at least partly light transmissive property, and the light source is provided behind the air permeable sheet in a part of the air duct adjacent to the air outlet.

5. The onboard air conditioning system according to claim 1, wherein the light source comprises a linear light source extending at least partly along the air outlet.

6. The onboard air conditioning system according to claim 1, wherein the air duct comprises an annular duct at least partly surrounding the air outlet, and defining a central chamber that has a closed bottom and an open top defining the air outlet, the annular air duct being provided with a communication hole communicating an interior of the annular duct with the central chamber.

7. The onboard air conditioning system according to claim 6, wherein a plurality of communicating holes are provided in an inner circumferential wall of the annular duct surrounding the central chamber along a length thereof.

8. The onboard air conditioning system according to claim 7, wherein the light source is mounted on the annular duct.

9. The onboard air conditioning system according to claim 1, wherein the interior member is selected from a group consisting of an instrument panel, door garnish, sheet bottom, seat back and rear shelf of a motor vehicle.

10. The onboard air conditioning system according to claim 1, wherein the interior member comprises an instrument panel, and the air outlet comprises a defroster air outlet formed in the instrument panel along a lower edge of a front windshield, the light source extending along a length of the defroster air outlet.
